(19) United States
(12) Patent Application Publication
(10) Pub. No.: US 2020/0076261 A1
(43) Pub. Date: Mar. 5, 2020

(54) ANNULAR STATOR OF AN ELECTRIC MOTOR

(71) Applicant: Mahle International GmbH, Stuttgart (DE)

(72) Inventors: Karl-Martin Fritsch, Stuttgart (DE); Christoph Schmuelling, Leutenbach (DE)

(21) Appl. No.: 16/552,791

(22) Filed: Aug. 27, 2019

(30) Foreign Application Priority Data
Aug. 28, 2018 (DE) 102018214525.3

(51) Int. Cl. H02K 3/24; H02K 1/16; H02K 3/02; H02K 3/12; H02K 15/085

(52) U.S. Cl. CPC H02K 3/24; H02K 1/16; H02K 15/085; H02K 3/12; H02K 3/02

(57) ABSTRACT

An annular stator of an electric motor may include rectangular hairpin stator coils extending in a radial direction and having a rectangular copper wire, rectangular stator teeth arranged in a circumferential direction between two adjacent hairpin stator coils, such that a wedge-shaped interspace may be between each hairpin stator coil and an adjacent stator tooth, and a heat-transmitter arranged on each of two longitudinal sides of each hairpin stator coil, at least partially filling the wedge-shaped interspace and connecting the respective hairpin stator coil to the adjacent stator tooth in a heat-transmitting manner.

### CROSS-REFERENCE TO RELATED APPLICATIONS

This application claims priority to German Patent Application No. DE 10 2018 214 525.3, filed Aug. 28, 2018, the contents of which are hereby incorporated in its entirety.

### TECHNICAL FIELD

The present invention relates to an annular stator of an electric motor. The invention also relates to an electric motor having such a stator and to a method for producing such a stator.

### BACKGROUND

Stator coils of electric motors are produced for example by winding thin, round copper wire and then installed in a stator of an electric motor. Such a stator is customarily annular and has, for example, radially inwardly directed stator teeth which are arranged at a distance from one another in the circumferential direction. Here, the stator coils are arranged between the individual stator teeth. Here, the stator teeth have a rectangular cross section, which makes it possible to achieve a constant magnetic flux density in the radial direction. In the case of rectangular stator teeth, the grooves or interspaces arranged therebetween for the stator coils are trapezoidal, which is not serious in relation to the copper filling factor when using round copper wire for the stator coils. On the other hand, however, in order to be able to generate a high magnetic force with the stator coil and thus achieve a high efficiency/power of the electric motor, cross-sectionally rectangular stator coils with a high copper filling factor are more favourable. However, if cross-sectionally rectangular stator coils are used in order to be able to achieve a high efficiency or power density via the high copper filling factor, it is required for the stator teeth situated between the individual stator coils to be cross-sectionally trapezoidal, which can result in particular in a lower magnetic flux density at a radially outer foot of the stator tooth and thus in a lower power of the electric motor.

### SUMMARY

The present invention is therefore concerned with the problem of specifying, for a stator, an improved or at least one alternative embodiment which particularly overcomes the disadvantages known from the prior art.

This problem is solved according to the invention by the subject matter of the dependent claims. Advantageous embodiments form the subject matter of the dependent claims.

The present invention is based on the general concept of using, for an annular stator of an electric motor, (cross-sectionally) rectangular hairpin stator coils which have a (cross-sectionally) rectangular copper wire and thus a particularly high copper filling factor and a high power. According to the invention, the annular stator of the electric motor has likewise cross-sectionally rectangular stator teeth which extend in the radial direction and between each of which a hairpin stator coil is arranged. A cross-sectionally trapezoidal stator tooth having the disadvantages known from the prior art (non-constant magnetic flux density in the radial direction) can thus be avoided, as can a round-wire stator coil which is inferior in terms of its power. By virtue of the fact that both the hairpin stator coils and the stator teeth each have a rectangular cross-sectional shape, a wedge-shaped interspace in each case remains between them in the installed state. This interspace is now used according to the invention to cool the hairpin stator coils. On each longitudinal side of each hairpin stator coil there is therefore arranged a heat-transmitting element which at least partially, preferably even completely, fills the wedge-shaped interspace between the hairpin stator coil and the adjacent stator tooth and connects the respective hairpin stator coil to the adjacent stator tooth in a heat-transmitting manner and/or cools said coil. It is thus possible for the first time with the annular stator according to the invention to use cross-sectionally rectangular stator coils which are optimized in terms of their magnetic flux density, and also cross-sectionally rectangular stator teeth, wherein the wedge-shaped interspaces remaining on account of the rectangular shape both of the stator coils and of the stator teeth are at least partially filled by the above-described heat-transmitting elements. Here, these heat-transmitting elements preferably do not, or only marginally, reduce a magnetic flux density and serve in particular for the heat dissipation of the stator coils, with the result that the power thereof can be increased.

In an advantageous development of the solution according to the invention, the hairpin stator coil and the two associated heat-transmitting elements form a prefabricated assembly. In concrete terms, this means that the two heat-transmitting elements are first mounted, for example by soldering, on the opposite longitudinal sides of the respective hairpin stator coil, with the result that the prefabricated assembly is formed. Said assembly can then be inserted in a simple manner between two adjacent stator teeth of the stator. The mounting of the stator according to the invention can be considerably simplified by way of the prefabricated assembly.

At least one heat-transmitting element is expediently designed as a rectangular cooling duct which is arranged in a transition region of a longitudinal side into an adjoining narrow side of the hairpin stator coil. It is possible for example for cooling fluid to be channelled via such a cooling duct and thus for the respective stator coil to be cooled. It is particularly advantageous here if the heat-transmitting element is designed as a wedge-shaped cooling duct which extends over the entire longitudinal side of the hairpin stator coil. Large-area cooling over the entire longitudinal side of the respective stator coil is thereby possible.

In an advantageous development of the solution according to the invention, at least one heat-transmitting element is formed from a material having good thermal conductivity. Here, too, there can be provision that such a heat-transmitting element, which in this case does not form a duct but is of solid design, transmits heat from the stator coils into the stator teeth, with the heat being able to be removed there or directly via the heat-transmitting elements to the outside. The cooling of the annular stator can also be improved in this way and thus the power of an electric motor equipped with such a stator can be increased.

The present invention is further based on the general concept of equipping an electric motor with a stator as described in the preceding paragraphs, with the result that it has a considerably increased power on account of the stator coils, which are increased in terms of their magnetic field strength/flux density, and the possibility for cooling and the higher magnetic flux density, in particular on a foot of a respective stator tooth, on account of its rectangular cross-sectional shape.

The present invention is further based on the general concept of specifying a method for producing the stator described in the preceding paragraphs, in which first of all an annular stator having rectangular stator teeth extending in a radial direction is provided. Rectangular hairpin stator coils having cross-sectionally rectangular copper wire are then provided. Here, a heat-transmitting element is arranged on each longitudinal side of each hairpin stator coil and extends over the longitudinal side at least in certain regions. “Arranged” can mean in this case that the respective heat-transmitting element is connected in a heat-transmitting and fixed manner to the respective longitudinal side of the stator coil, for example is soldered thereto. The thus prefabricated hairpin stator coils are then inserted in the axial direction between the stator teeth, wherein a wedge-shaped interspace remaining between each hairpin stator coil and an adjacent stator tooth is at least partially, preferably even completely, filled by the heat-transmitting element arranged therein and thus connects the respective hairpin stator coil to the adjacent stator tooth in a heat-transmitting manner and/or cools said coil.

Here, the heat-transmitting elements can be of solid design or else hollow and in these cases serve as a cooling duct for feeding a cooling fluid. Purely theoretically, it is of course also conceivable that a heat-transmitting element is arranged in the interspace only in the region of a foot, that is to say a radially outer region of the stator tooth. In the case of a wedge-shaped design of such heat-transmitting elements, the latter can also fill the entire interspace.

The possibility of premounting the hairpin stator coil and the two heat-transmitting elements already prior to installation in the stator allows the mounting process to be further considerably simplified.

Further important features and advantages of the invention will become apparent from the subclaims, from the drawings and from the associated description of the figures on the basis of the drawings.

It will be appreciated that the features stated above and those still to be explained below can be used not only in the respectively indicated combination but also in other combinations or on their own without departing from the scope of the present invention.

Preferred exemplary embodiments of the invention are illustrated in the drawings and will be explained in more detail in the following description, with identical reference signs referring to identical or similar or functionally identical components.

### BRIEF DESCRIPTION OF THE DRAWINGS

In the drawings,

FIG. 1 schematically shows a detail of an annular stator according to the invention of an electric motor,

FIG. 2 schematically shows a first possible embodiment of a hairpin stator coil having two solid heat-transmitting elements,

FIG. 3 schematically shows an illustration as in FIG. 2, but with two hollow heat-transmitting elements which are designed as a rectangular cooling duct,

FIG. 4 schematically shows a further embodiment of a hairpin stator coil of a stator according to the invention having wedge-shaped heat-transmitting elements.

### DETAILED DESCRIPTION

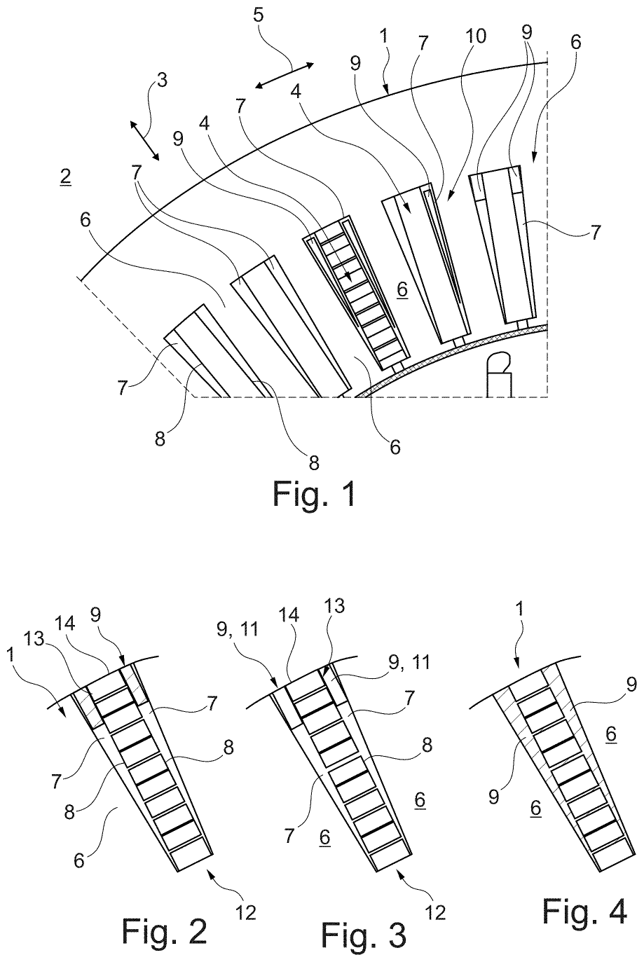

As shown in FIG. 1, an annular stator 1 according to the invention of an electric motor 2 (otherwise not shown) has cross-sectionally rectangular hairpin stator coils 4 which extend in the radial direction 3 and which each have or are produced from a rectangular copper wire. Such hairpin stator coils 4 are also shown in FIGS. 2 to 4. A likewise cross-sectionally rectangular stator tooth 6 is in each case arranged in the circumferential direction 5 between two adjacent hairpin stator coils 4, with the result that both the cross-sectional shape of the stator teeth 6 and the cross-sectional shape of the hairpin coils 4 is rectangular. Here, the hairpin stator coils 4 and the stator teeth 6 arranged therebetween of course also extend in the direction of the image plane, that is to say in the axial direction of the stator 1. By virtue of the circular shape of the stator 1, a wedge-shaped interspace 7 remains between each hairpin stator coil 4 and an adjacent stator tooth 6, wherein a heat-transmitting element 9 is arranged on each longitudinal side 8 of each hairpin stator coil 4, at least partially fills the wedge-shaped interspace 7 and connects the respective hairpin stator coil 4 to the adjacent stator tooth 6 in a heat-transmitting manner and/or cools said coil.

The cross-sectionally rectangular shape according to the invention both of the hairpin stator coils 4 and of the stator teeth 6 arranged therebetween in the circumferential direction 5 means that a considerably higher magnetic flux density, and thus overall a constant flux density, can be achieved in particular in a foot region 10 of each stator tooth 6, that is to say in a radially outer region of the respective stator tooth 6. Moreover, the use of the rectangular copper wire and the configuration of the respective stator coils as hairpin stator coils 4 makes it possible to achieve a high copper filling degree or copper filling factor, which contributes to increasing the power density. In the stator 1 according to the invention, the cross-sectionally rectangular stator teeth 6 thus make it possible to achieve a constant and high magnetic flux density, and the likewise cross-sectionally rectangular hairpin stator coils 4 make it possible to achieve a high magnetic field strength/flux density or power density, thus contributing to being able to create a high-power electric motor 2.

It is particularly preferred here if the hairpin stator coil 4 and the two heat-transmitting elements 9 arranged therein form a prefabricated assembly such that they can be inserted as a prefabricated assembly into the stator 1 or into the openings provided there.

If the individual embodiments of the hairpin stator coils 4 according to FIGS. 2 to 4 are now considered, it can thus be seen in FIG. 2 that two heat-transmitting elements 9, which are of solid design, are arranged there in a respective foot region 10 on the longitudinal sides 8 of the hairpin stator coil 4. In this way, an optimized heat connection to the adjacent stator teeth 6 and/or to the outside can be achieved.

If the heat-transmitting element 9 is designed for example as a rectangular cooling duct 11 or as a rectangular, solid component, it can be arranged in a transition region 13 of a longitudinal side 8 into an adjoining narrow side 14 of the hairpin stator coil 4.

According to FIG. 3, the heat-transmitting elements 9 are hollow in design and designed as a rectangular cooling duct 11 in which, for example, a cooling fluid for cooling the hairpin stator coils 4 can circulate. According to FIG. 4, by contrast, wedge-shaped heat-transmitting elements 9 are shown which cover the entire surface of the longitudinal sides 8 and completely fill the interspaces 7. This makes possible a particularly optimized heat-transmitting connection to the adjacent stator teeth 6. The heat-transmitting elements 9 are of solid design in this case, with it being possible according to FIG. 1 for such wedge-shaped heat-transmitting elements 9 also to be hollow in design such that cooling fluid can circulate therein.

Here, at least one of the heat-transmitting elements 9 is fixedly connected, in particular soldered or adhesively bonded, to the respectively associated longitudinal side 8 of the hairpin stator coil 4, with soldering allowing a particularly high heat transmission.

In this case, the stator 1 according to the invention is produced as follows:

First of all, an annular stator 1 having rectangular stator teeth 6 extending in the radial direction 3 is provided. Also provided are rectangular hairpin stator coils 4 having rectangular copper wire. Here, a heat-transmitting element 9 is arranged, for example by soldering, on each longitudinal side 8 of the hairpin stator coils 4, and a prefabricated assembly is thus created. The thus prefabricated assembly is then inserted in the axial direction, that is to say in the present case perpendicularly to the image plane according to FIG. 1, between the stator teeth 6, wherein a wedge-shaped interspace 7 remaining between each hairpin stator coil 4 and an adjacent stator tooth 6 is at least partially filled by the heat-transmitting element 9 arranged therein and thus connects the respective hairpin stator coil 4 to the adjacent stator tooth 6 in a heat-transmitting manner and/or contributes to cooling the hairpin stator coil 4. The heat-transmitting elements 9 allow improved cooling of the hairpin stator coils 4 to be achieved and thus their efficiency to be increased. Purely theoretically, it is even conceivable to use the rectangular copper wire on the longitudinal sides 8 of the hairpin stator coil 4 as a wall of a cooling duct in order thereby to maximize a flow cross section.

An advantage of the production method according to the invention is that mounting, function testing and contacting can occur outside the electric motor 2 such that the individual components can be delivered, prepared and tested, for mounting. By virtue of the fact that the heat-transmitting element 9 is designed for example as a rectangular cooling duct 11 or as a rectangular, solid component, it can be arranged in a transition region 13 of a longitudinal side 8 into an adjoining narrow side 14 of the hairpin stator coil 4.

1. An annular stator of an electric motor, comprising:
rectangular hairpin stator coils extending in a radial direction and having a rectangular copper wire;
rectangular stator teeth arranged in a circumferential direction between two adjacent hairpin stator coils, such that a wedge-shaped interspace is between each hairpin stator coil and an adjacent stator tooth; and
a heat-transmitter arranged on each of two longitudinal sides of each hairpin stator coil, at least partially filling the wedge-shaped interspace and connecting the respective hairpin stator coil to the adjacent stator tooth in a heat-transmitting manner.

2. The stator according to claim 1, wherein each hairpin stator coil and the heat-transmitter on each of the two longitudinal sides form a prefabricated assembly.

3. The stator according to claim 1, wherein at least one heat-transmitter is designed as a rectangular cooling duct arranged in a transition region of a respective one of the two longitudinal sides into an adjoining narrow side of the respective hairpin stator coil.

4. The stator according to claim 1, wherein at least one heat-transmitter is designed as a wedge-shaped cooling duct extending over a respective one of the two longitudinal sides of the respective hairpin stator coil.

5. The stator according to claim 1, wherein at least one heat-transmitter is formed from a thermal conductive material.

6. The stator according to claim 1, wherein at least one heat-transmitter is soldered to the respective hairpin stator coil.

7. An electric motor comprising a stator and a rotor arranged therein, the stator having:
rectangular hairpin stator coils extending in a radial direction and having a rectangular copper wire;
rectangular stator teeth arranged in a circumferential direction between two adjacent hairpin stator coils, such that a wedge-shaped interspace is between each hairpin stator coil and an adjacent stator tooth; and
a heat-transmitter arranged on each of two longitudinal sides of each hairpin stator coil, at least partially filling the wedge-shaped interspace and connecting the respective hairpin stator coil to the adjacent stator tooth in a heat-transmitting manner.

8. A method for producing a stator comprising:
providing an annular stator having rectangular stator teeth extending in a radial direction;
providing rectangular hairpin stator coils each having a rectangular copper wire;
arranging a heat-transmitter on each of two longitudinal sides of each hairpin stator coil to produce a prefabricated assembly;
inserting the hairpin stator coils with the heat-transmitter arranged thereon in an axial direction between the stator teeth, wherein a wedge-shaped interspace between each hairpin stator coil and an adjacent stator tooth is at least partially filled by the heat-transmitter arranged therein and connects the respective hairpin stator coil to the adjacent stator tooth (6) in a heat-transmitting manner.

9. The method according to claim 8, wherein at least one heat-transmitter is designed as a rectangular cooling duct arranged in a transition region of a respective one of the two longitudinal sides into an adjoining narrow side of the respective hairpin stator coil.

10. The method according to claim 8, wherein at least one heat-transmitter is designed as a wedge-shaped cooling duct extending over a respective one of the two longitudinal sides of the respective hairpin stator coil.

11. The method according to claim 8, wherein at least one heat-transmitter is formed from a thermal conductive material.

12. The method according to claim 8, wherein at least one heat-transmitter is soldered to the respective hairpin stator coil.

13. The electric motor of claim 7, wherein each hairpin stator coil and the heat-transmitter on each of the two longitudinal sides form a prefabricated assembly.

14. The electric motor according to claim 7, wherein at least one heat-transmitter is designed as a rectangular cooling duct arranged in a transition region of a respective one of the two longitudinal sides into an adjoining narrow side of the respective hairpin stator coil.

15. The electric motor according to claim 7, wherein at least one heat-transmitter is designed as a wedge-shaped cooling duct extending over a respective one of the two longitudinal sides of the respective hairpin stator coil.

16. The electric motor according to claim 7, wherein at least one heat-transmitter is formed from a thermal conductive material.

17. The electric motor according to claim 7, wherein at least one heat-transmitter is soldered to the respective hairpin stator coil.

18. The stator according to claim 2, wherein at least one heat-transmitter is designed as a rectangular cooling duct arranged in a transition region of a respective one of the two longitudinal sides into an adjoining narrow side of the respective hairpin stator coil.

19. The stator according to claim 2, wherein at least one heat-transmitter is designed as a wedge-shaped cooling duct extending over a respective one of the two longitudinal sides of the respective hairpin stator coil.

20. The stator according to claim 2, wherein at least one heat-transmitter is soldered to the respective hairpin stator coil.
